(19) United States
(12) Patent Application Publication
(10) Pub. No.: US 2009/0053057 A1
(43) Pub. Date: Feb. 26, 2009

(54) Wind powered rotor mechanism with means to enhance airflow over rotor

(76) Inventor: George R. Royer, Toledo, OH (US)

Correspondence Address: George R. Royer, 2137 RAGAN WOODS DR, TOLEDO, OH, 43614, US

(21) Appl. No.: 11/894,059

(22) Filed: Aug. 20, 2007

(51) Int. Cl. F03D 1/00; F03D 11/00

(52) U.S. Cl. 415/220

(57) ABSTRACT

The subject apparatus device which incorporates structural aspects of the invention herein is a wind powered rotor mechanism, such rotor mechanism having a central rotational axle rotationally installed through and within or adjacent to an open shroud or chamber, such rotational axle having air movement sensitive means to receive the impact of any oncoming air movement, such wind sensitive means generally being in the form of a rotor member for direct rotational drive of the rotational axle, in which the rotor member is partially or fully enclosed in such shroud or positioned just outside of such shroud, herein such rotor member being positioned just in front of a frontal opening of the shroud, facing generally oncoming wind flows where such frontal opening of such shroud leads into a spatial chamber within such shroud, such spatial area extending away from the turbine rotor, wherein the chamber in the shroud has an exit opening for air to flow out of such chamber.

### DISCUSSION OF PRIOR ART AND RELEVANT BACKGROUND

Energy conversion devices can potentially utilize wind to drive a rotor mechanism for ultimate energy generated for usage in mechanical, electrical or other forms. Devices incorporating features using wind energy indirectly and directly to drive a rotor mechanism would be more economical if means are provided to enhance the wind flow over a turbine motor.

More directly, means to combine the driving force of air movement are not presently available to augment energy output. More specifically, in this area of energy conversion, there are no effective devices structured to alternately and simultaneously capture the maximum extent of wind energy or increase separately the ambient flow of the wind thereof so as to increase the drive force on a wind driven rotor mechanism, thereby increasing the energy output productivity of the apparatus.

With increasing emphasis on alternate energy sources, there is need therefore to increase the efficiency of wind driven devices with means to augment wind flow, partially in light of present climatology circumstances.

### OBJECTS OF INVENTION

In view of the foregoing circumstances, it is an object of the subject invention to provide an improved energy conversion device, using wind power;

Yet another object of the subject invention is to provide an improved environmentally sound energy conversion device that is relatively pollution free;

Another object of the subject invention is to provide an improved apparatus to capture and augment wind power for increasing the rotor speed of a wind turbine structure;

Still another object of the subjection invention is to provide a relatively efficient energy source;

A further object of the subject invention is to provide an improved device for using wind power sources;

It is also an object of the subject invention to provide an improved energy conversion mechanism;

Yet another object of the subject invention is to provide a dynamic and continuously operated mechanism to increase the wind flow over a wind turbine for purposes of generating more energy derived from the wind turbine;

Other objects of the subject invention will become apparent from a reading of the description taken in conjunction with the claims.

### BRIEF DESCRIPTION OF THE DRAWINGS

FIG. 1 is a side elevational view of wind turbine;

FIG. 2 is a perspective view of the subject invention mounted in front of a shroud housing air intake opening;

FIG. 3 is a side view of the subject invention shown partially cut away to demonstrate internal features, with the turbine blades being mounted in front of the shroud housing;

FIG. 4 is a side elevational view of the subject invention; in section, showing the subject invention with the wind turbine blades being mounted just inside the shroud housing;

FIG. 5 is a side elevational view showing the subject device being mounted on top of a hill with a shroud housing;

FIG. 6 demonstrates an alternate embodiment with the shroud housing chamber with a gradually decreasing chamber size as the chamber extends rewardly to the exit opening of the shroud chamber.

### SUMMARY OF INVENTION

The subject apparatus device which incorporates structural aspects of the invention herein is a wind powered rotor mechanism, such rotor mechanism having a central rotational axle rotationally installed through and within or adjacent to an open shroud or chambered member, such rotational axle having air movement sensitive means to receive the impact of any oncoming wind, such wind sensitive means generally being in the form of a rotor member for direct rotational drive of the rotational axle in which the rotor member is partially or fully enclosed in such shroud chamber or wherein such rotor member is positioned in front of the frontal opening of the shroud, or close thereto, and wherein such frontal opening of such shroud leads into an open spatial chamber within such shroud, such spatial chamber extending away from the turbine rotor member, and further wherein the chamber in such shroud has an exit opening for air to flow out of such chamber.

In summarizing the general embodiment of the subject invention it is important to note, as is well known, that wind generated devices driven for energy purposes, are all subject to and dependent on the vagaries of wind force at an given time. In some areas, there is no real effective economic output for energy generation, because of little or no wind flow. Further, in summer months in many areas the winds diminish dramatically. For these reasons, the methodology herein is deployed to increase wind or air flow over the wind turbine rotors. In this light, the subject invention involves placement of a wind turbine rotor in front of an open shroud or in the shroud chamber, with the open shroud having an open chamber with openings in the front and rear and portions of the chamber. The idea is to employ means to create a partial vacuum within the shroud chamber so that air is more readily drawn into the chamber because of the partial vacuum effect, by this process will increase the air flow into the shrouds chamber and thus over the wind turbine rotor blades positioned at the front of shroud chamber.

In order to accomplish increased air flow over the wind turbine rotor, a partial vacuum is created in the shroud chamber by one or more of the following physical features deployed within the shroud chamber or by the very nature of the shroud structure itself, or other features not specifically delineated below:

(a) affixing one or more vacuum pumps within the shroud chamber near the middle or posterior portion of the shroud chamber, although such vacuum pumps can be placed anywhere within the shroud chamber to help create a partial vacuum with such chamber;

(b) structuring the internal size and shape of the interior chamber of the shroud in such a manner so to create a bernoulli effect as the air passes through the shroud chamber to the exit opening of the shroud chamber, to thereby accelerate the air flow through the shroud chamber and create less air pressure in the upwind area of the shroud chamber;

(c) other means to create a partial vacuum in the shroud chamber or decrease air pressure in the front of the shroud chamber to increase air flow.

The subject device which incorporates structural aspects of the subject invention is thus focused on a wind powered rotor mechanism, specifically utilizing energy from wind sources to provide energy to drive a rotor mechanism, such apparatus comprising general form a longitudinally extending shroud structure with an internal longitudinally extending chamber, or having a chamber of some longitudinal extent. Such structure has an air intake opening at some position for air intake generally positioned at the frontal or upwind portion of the shroud and an air outlet opening between the frontal or upwind portion and rear portion of the shroud chamber. Such frontal opening communicates with outside air to the central longitudinally extending shroud chamber that extends rearwardly towards the posterior part of the shroud. The longitudinal extending chamber in one embodiment is formed to help accelerate the rearwind flow of the air in the shroud chamber to the exit opening, with a decreasing circumference as it extends rearwardly to the exit opening of the shroud chamber.

To this end, the device has a wind driven rotor mechanism positioned at or near the frontal portion of the chamber, such rotor mechanism having a central rotational axle rotationally installed longitudinally through such shroud chamber or adjacent to such shroud chamber, such rotational axle having means thereon in certain embodiments to drive auxiliary vacuum pumps with the shroud chamber. By reason of the partial vacuum in such shroud chamber, air flow will increase by some degree as it moves into such shroud chamber in front of the opening in the shroud chamber and this increase in flow into the shroud chamber is caused basically by the suction effect of the partial vacuum created in the shroud chamber by the mechanisms or processes outlined above, thereby increasing the wind flow over the wind driven rotor as so positioned. The wind air flow off the rotor, once having passed over the frontal opening of the shroud chamber, will pass through the shroud chamber in a longitudinal manner and thence through the gradually narrowing chamber as it flows to the exit opening and such air flow will accelerate as such air flow passes through the gradually decreased circumference of the shroud chamber by reason the Bernoulli effect created in the chamber. To some extent this latter structural and aerodynamic phenomena will help create a partial vacuum in the shroud chamber near the upwind portion of the shroud chamber and thus accelerate and increase wind flow through the chamber. This latter phenomenon will cause a relative increase in air flow into the shroud chamber at the frontal opening of the shroud chamber, near which is positioned the turbine blades by the reduced air pressure or suction effect of air flowing into the chamber.

Thus, the idea herein is to employ means to create a partial vacuum within the chamber so that air is more readily drawn into the chamber because of the partial vacuum effect. This in turn, will increase the air flow over the wind turbine blades and improve the efficiency of the wind driven rotor member.

Alternately stated, the subject apparatus incorporating features of the subject invention is directed to a wind powered rotor mechanism, specifically having an open chamber positioned over or near the wind driven rotor, such apparatus comprising in its general form a shroud or housing member having a partially enclosed chamber with an air intake opening at the frontal end of such housing and an air exit opening at some other portion of the shroud. In the general embodiment of the subject invention, the open end of the shroud or housing will be positioned ideally at or near the wind driven rotor member. Thus, when oncoming wind reaches and impacts against the wind driven rotor frontally, such impacting air will thence pass directly into the shroud or housing chamber, since the rotor will be positioned just in front of or just within the front opening of the shroud chamber, and as such air passes into the shroud chamber it will be almost immediately be subjected to the gradually decreasing diameter of the shroud chamber as air passes through such chamber. Such moving air in the shroud chamber will reduce to some degree air pressure from behind the air flow into and air intensity at or near the frontal end of the shroud chamber and will create in effect a partial vacuum or decreased air pressure in the frontal portion of the shroud chamber. This partial vacuum or reduced air pressure at the frontal portion of the shroud chamber will continue as air is pulled into the front of the shroud chamber and thereby help increase the air flow continuously near the bladed rotor member.

The shroud housing is exposed to outside air and for this purpose is ideally aligned parallel, as to its longitudinal central axis, to the direction of flow prevailing winds and is structurally adapted to admit air flow into the longitudinal extending chamber as aligned with the prevailing wind flow. For this purpose the shroud housing can be mounted for rotation in a substantially horizontal plane about a vertical axis to be freely movable about such axis for alignment with the existing wind direction. A portion of the shroud chamber can be structured to receive and potentially support the wind turbine rotor axle near the middle inside portion or other portions of the shroud housing chamber, such rotor axle mechanism having a central rotational axle rotationally installed preferably along or parallel to the longitudinal central axis of such chamber, and extending longitudinally into such chamber with such rotor member anchored in one or more fixed bearing members in such chamber for free rotational movement in such bearing member or members. In alternate arrangements, a secondary wind driven rotor can both be installed or positioned on such rotor axle for auxiliary power purposes, such as powering one or more vacuum pumps, as suggested above, along with a potential for supplementary energy output in addition to that generated by main rotor member. This secondary rotor, if deployed, can be affixed on the main rotor or air auxiliary rotor either in the shroud chamber just outside the shroud chamber and perhaps being the shroud chamber facing the exit opening of the shroud chamber.

In summary and in general, the subject invention is based around a base shroud housing member generally having any disposition and having a hollow internal chamber with an air inlet opening to admit air into such chamber, with a wind movement powered turbine members located either in such chamber or outside such chamber, with the turbine blades of such bases rotor being positioned to receive any oncoming air movements through such chamber so as to rotate such base rotor around its longitudinal central axis.

As stated above, in one of several alternate structural arrangements of subject device, the subject invention may have separate rotor means affixed on an independent or secondary rotor aside from the base rotor or affixed on a different portion of the base rotor. This separate or secondary rotor means is also structured to and positioned to receive wind forces flowing from air inside the shroud chamber against such secondary rotor means. Thus, head-on air currents entering the shroud chamber from the outside drive the secondary rotor or base rotor, thereby producing dual drive forces in the overall mechanism.

In summary and in general, the subject invention is based around a base member generally of upright deposition and having a hollow internal chamber with an air inlet opening to admit air into such chamber and an air movement powered base rotor located either in such chamber or outside such chamber, with the rotor blades of such bases rotor being positioned to receive any air movements through such chamber so as to rotate such base rotor around its longitudinal central axis.

More directly, the subject apparatus is generally adapted to have means therein to admit outside air into the chamber so that the solar heat generated in the chamber will help accelerate through convection means or other wise to move such air admitted in to the chamber to facilitate and increase the speed of the admitted air into the chamber and thence out of the air outlet opening onto the rotor blades.

### DESCRIPTION OF CERTAIN SPECIFIC EMBODIMENTS OF SUBJECT INVENTION

The following description of one or more specific embodiments shall not be construed to limit the scope of the claims annexed hereto, as other embodiments may be considered to be in the scope of the invention herein. Therefore the following description will not be construed to limit the scope of the claims hereto.

The subject apparatus device which incorporates structural aspects of the invention herein is a wind powered rotor mechanism, such rotor mechanism having a central rotational axle rotationally installed through and within or adjacent to an open shroud or chambered member, such rotational axle having air movement sensitive means to receive the impact of any oncoming wind, such wind sensitive means generally being in the form of a rotor member for direct rotational drive of the rotational axle in which the rotor member is partially or fully enclosed in such shroud chamber or wherein such rotor member is positioned in front of the frontal opening of the shroud, or close thereto, and wherein such frontal opening of such shroud leads into an open spatial chamber within such shroud, such spatial chamber extending away from the turbine rotor member, and further wherein the chamber in such shroud has an exit opening for air to flow out of such chamber.

In summarizing the general embodiment of the subject invention it is important to note, as is well known, that wind generated devices driven for energy purposes, are all subject to and dependent on the vagaries of wind force at an given time. In some areas, there is no real effective economic output for energy generation, because of little or no wind flow. Further, in summer months in many areas the winds diminish dramatically. For these reasons, the methodology herein is deployed to increase wind or air flow over the wind turbine rotors. In this light, the subject invention involves placement of a wind turbine rotor in front of an open shroud or in the shroud chamber, with the open shroud having an open chamber with openings in the front and rear and portions of the chamber. The idea is to employ means to create a partial vacuum within the shroud chamber so that air is more readily drawn into the chamber because of the partial vacuum effect, by this process will increase the air flow into the shrouds chamber and thus over the wind turbine rotor blades positioned at the front of shroud chamber.

In order to accomplish increased air flow over the wind turbine rotor, a partial vacuum is created in the shroud chamber by one or more of the following physical features deployed within the shroud chamber or by the very nature of the shroud structure itself, or other features not specifically delineated below:

(a) affixing one or more vacuum pumps within the shroud chamber near the middle or posterior portion of the shroud chamber, although such vacuum pumps can be placed anywhere within the shroud chamber to help create a partial vacuum with such chamber;

(b) structuring the internal size and shape of the interior chamber of the shroud in such a manner so to create a bernoulli effect as the air passes through the shroud chamber to the exit opening of the shroud chamber, to thereby accelerate the air flow through the shroud chamber and create less air pressure in the upwind area of the shroud chamber;

(c) other means to create a partial vacuum in the shroud chamber or decrease air pressure in the front of the shroud chamber to increase air flow.

The subject device which incorporates structural aspects of the subject invention is thus focused on a wind powered rotor mechanism, specifically utilizing energy from wind sources to provide energy to drive a rotor mechanism, such apparatus comprising general form a longitudinally extending shroud structure with an internal longitudinally extending chamber, or having a chamber of some longitudinal extent. Such stucture has an air intake opening at some position for air intake generally positioned at the frontal or upwind portion of the shroud and an air outlet opening between the frontal or upwind portion and rear portion of the shroud chamber. Such frontal opening communicates with outside air to the central longitudinally extending shroud chamber that extends rearwardly towards the posterior part of the shroud. The longitudinal extending chamber in one embodiment is formed to help accelerate the rearwind flow of the air in the shroud chamber to the exit opening, with a decreasing circumference as it extends rearwardly to the exit opening of the shroud chamber.

To this end, the device has a wind driven rotor mechanism positioned at or near the frontal portion of the chamber, such rotor mechanism having a central rotational axle rotationally installed longitudinally through such shroud chamber or adjacent to such shroud chamber, such rotational axle having means thereon in certain embodiments to drive auxiliary vacuum pumps with the shroud chamber. By reason of the partial vacuum in such shroud chamber, air flow will increase by some degree as it moves into such shroud chamber in front of the opening in the shroud chamber and this increase in flow into the shroud chamber is caused basically by the suction effect of the partial vacuum created in the shroud chamber by the mechanisms or processes outlined above, thereby increasing the wind flow over the wind driven rotor as so positioned. The wind air flow off the rotor, once having passed over the frontal opening of the shroud chamber, will pass through the shroud chamber in a longitudinal manner and thence through the gradually narrowing chamber as it flows to the exit opening and such air flow will accelerate as such air flow passes through the gradually decreased circumference of the shroud chamber by reason the Bernoulli effect created in the chamber. To some extent this latter structural and aerodynamic phenomena will help create a partial vacuum in the shroud chamber near the upwind portion of the shroud chamber and thus accelerate and increase wind flow through the chamber. This latter phenomenon will cause a relative increase in air flow into the shroud chamber at the frontal opening of the shroud chamber, near which is positioned the turbine blades by the reduced air pressure or suction effect of air flowing into the chamber.

Thus, the idea herein is to employ means to create a partial vacuum within the chamber so that air is more readily drawn into the chamber because of the partial vacuum effect. This in turn, will increase the air flow over the wind turbine blades and improve the efficiency of the wind driven rotor member.

Alternately stated, the subject apparatus incorporating features of the subject invention is directed to a wind powered rotor mechanism, specifically having an open chamber positioned over or near the wind driven rotor, such apparatus comprising in its general form a shroud or housing member having a partially enclosed chamber with an air intake opening at the frontal end of such housing and an air exit opening at some other portion of the shroud. In the general embodiment of the subject invention, the open end of the shroud or housing will be positioned ideally at or near the wind driven rotor member. Thus, when oncoming wind reaches and impacts against the wind driven rotor frontally, such impacting air will thence pass directly into the shroud or housing chamber, since the rotor will be positioned just in front of or just within the front opening of the shroud chamber, and as such air passes into the shroud chamber it will be almost immediately be subjected to the gradually decreasing diameter of the shroud chamber as air passes through such chamber. Such moving air in the shroud chamber will reduce to some degree air pressure from behind the air flow into and air intensity at or near the frontal end of the shroud chamber and will create in effect a partial vacuum or decreased air pressure in the frontal portion of the shroud chamber. This partial vacuum or reduced air pressure at the frontal portion of the shroud chamber will continue as air is pulled into the front of the shroud chamber and thereby help increase the air flow continuously near the bladed rotor member.

The shroud housing is exposed to outside air and for this purpose is ideally aligned parallel, as to its longitudinal central axis, to the direction of flow prevailing winds and is structurally adapted to admit air flow into the longitudinal extending chamber as aligned with the prevailing wind flow. For this purpose the shroud housing can be mounted for rotation in a substantially horizontal plane about a vertical axis to be freely movable about such axis for alignment with the existing wind direction. A portion of the shroud chamber can be structured to receive and potentially support the wind turbine rotor axle near the middle inside portion or other portions of the shroud housing chamber, such rotor axle mechanism having a central rotational axle rotationally installed preferably along or parallel to the longitudinal central axis of such chamber, and extending longitudinally into such chamber with such rotor member anchored in one or more fixed bearing members in such chamber for free rotational movement in such bearing member or members. In alternate arrangements, a secondary wind driven rotor can both be installed or positioned on such rotor axle for auxiliary power purposes, such as powering one or more vacuum pumps, as suggested above, along with a potential for supplementary energy output in addition to that generated by the main rotor member. This secondary rotor, if deployed, can be affixed on the main rotor or air auxiliary rotor either in the shroud chamber just outside the shroud chamber and perhaps being the shroud chamber facing the exit opening of the shroud chamber.

In summary and in general, the subject invention is based around a base shroud housing member generally having any disposition and having a hollow internal chamber with an air inlet opening to admit air into such chamber, with a wind movement powered turbine members located either in such chamber or outside such chamber, with the turbine blades of such bases rotor being positioned to receive any oncoming air movements through such chamber so as to rotate such base rotor around its longitudinal central axis.

As stated above, in one of several alternate structural arrangements of subject device, the subject invention may have separate rotor means affixed on an independent or secondary rotor aside from the base rotor or affixed on a different portion of the base rotor. This separate or secondary rotor means is also structured to and positioned to receive wind forces flowing from air inside the shroud chamber against such secondary rotor means. Thus, head-on air currents entering the shroud chamber from the outside drive the secondary rotor or base rotor, thereby producing dual drive forces in the overall mechanism.

In summary and in general, the subject invention is based around a base member generally of upright deposition and having a hollow internal chamber with an air inlet opening to admit air into such chamber and an air movement powered base rotor located either in such chamber or outside such chamber, with the rotor blades of such bases rotor being positioned to receive any air movements through such chamber so as to rotate such base rotor around its longitudinal central axis.

More directly, the subject apparatus is generally adapted to have means therein to admit outside air into the chamber so that the solar heat generated in the chamber will help accelerate through convection means or other wise to move such air admitted in to the chamber to facilitate and increase the speed of the admitted air into the chamber and thence out of the air outlet opening onto the rotor blades.

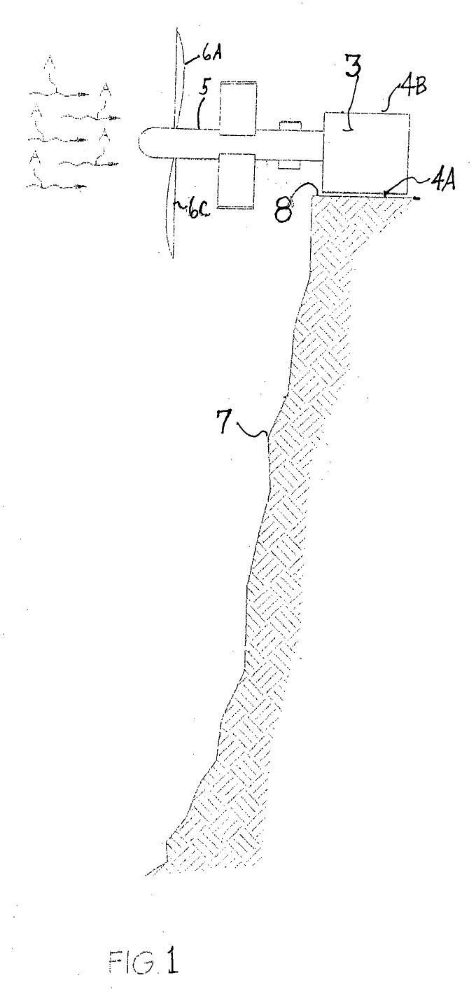

As to specific embodiments of the subject invention, referring to the drawings and particularly FIGS. 1, 2, 3, 4 and 5 shown is a wind turbine structure 2 in a generally conventional structural arrangement. Specifically shown as comprising such overall wind turbine structure is a base support member 3 with a lower end 4A and an upper end 4B on which a wind turbine rotor 5 with rotor blades 6A, 6B, 6C and 6D are mounted. Rotor member 5 is positioned generally and situated in a position substantially above the ground so that rotor 5 is postured ideally, but not critically, parallel to the ground and a distance above the ground to capture the maximum effects of the ambient wind flow. The base member 3 may be a tower or other man made structure or it may in fact be supported on a natural structure such as the top of a cliff 7, as shown in FIG. 1, with the upper ledge 8 of the cliff supporting the base member 3 with the turbine rotor blades 6A, 6B, 6C and 6D projecting out beyond the cliff ledge. The base member may have bearing means, not shown, to support the rotor member for free axial rotational movement therein. If a tower is utilized for a supportive structure, the upper part of the tower may have a base support member on the upper end or nearby. This invention is applicable however, any type of structure supporting a rotor shaft 5, such as a vertically free standing tower, as stated.

As indicated, the wind turbine blades 6A, 6B, 6C and 6D are affixed to rotor shaft 5 in such a manner that the wind turbine preferable projects directly and frontally towards the oncoming wind and thus, specifically extends frontwardly and generally perpendicularly to the cliff's vertical surface with the longitudinal axis of the wind turbine rotor 5 preferably aligned with the flow of any prevailing wind. For this purpose the rotor shaft member, as mounted through bearing surface elements in base member 3, can rotate about a vertical axis in a substantially horizontal plane. The rotor shaft 5 can be thence interconnected to a generator not shown, utilizing the rotational movement of rotor 5 as the energy source. As seen the rotor wind turbine blades 6A, 6B, 6C and 6D on rotor 5, as mounted, are fairly conventional in structural arrangement, as thus far described.

For a description of one specific embodiment of the subject invention, among several, attention is directed to the drawings, including 2, 3, 4 and 5 in which a wind enhancement base structure 10 is shown. Energy wind enhancement base structure 10 is preferably, but not essentially, a shroud structure being in the form of longitudinally extending shroud housing 20 that has a lower surface portion 30A and an upper surface portion 30B. The housing 20 additionally has a first end 40A and a second end 40B, with the first end considered to be the frontal portion or windward facing portion. Inside such shroud housing 20 proper is an internal longitudinally extending hollow chamber 50. Such chamber 50 in the specific embodiment described herein is basically a longitudinally extending spatial area within such shroud housing extending generally, but not essentially, from the first end 40A to the second end 40B of chamber 50 in shroud housing 20. Chamber 50 is disposed preferably, but not necessarily, aligned along the longitudinal disposition of such shroud housing 20 and is preferred to be aligned generally with the prevailing wind flow patterns, although this latter characteristic is not critical to implementation of the subject invention.

In such latter embodiment, it is not critical that the hollow chamber 50 be longitudinally extending or vertically extending and be in any symmetrical form or even assume an asymmetrical form. Also, it is not critical that the chamber 50 be aligned with the longitudinal central axis of the housing, as the shroud housing 20 itself may be aligned vertically or upright or in other dispositions relative to the ground or relative to the wind flow patterns for the given geographical area. At or near the windward or the frontal end or first end 40A of shroud 20 housing is an air intake opening 60A which is adapted to draw in wind or air currents into shroud housing chamber 50 from areas outside shroud housing 20, as such wind or air current arrive at or near the air intake opening 60A of the shroud housing 20. It is to be stated that the air intake opening 60A can be located at any position in or on the housing 20 and not necessarily near or adjacent to the frontal or windward portion thereof. However, it is optimal that the air intake opening 60A be on the windward and frontal end or first end 40A of shroud housing 20 and be faced towards the oncoming wind flow to minimize interference with wind flow as the wind flows into such intake opening 60A. The air intake opening 60A permits such wind flow to enter directly into shroud housing chamber 50 for flow through such chamber to be passed on the exit opening 60B of such chamber.

As expressed above, it is stressed that the base structure 10 be formed essentially as a housing, as set forth above, and be referred variously herein to as shroud housing 10 or shroud and may be structured otherwise than as set forth in the above described specific embodiment. More directly, the base structure or shroud housing 20 need not be constructed as a longitudinally extending member, nor need it be parallelopiped, oval or any other particular shape as seen from the side view other positional views. Moreover, the base structure 10 need not be upright as portrayed and it is not essential or critical that the air intake opening 60A be at first end of the shroud housing 20. The shroud housing 20 may be any configuration from any viewpoint and the internal hollow chamber in to the housing 20 need not be structured in the form shown and described above herein or below herein. Notwithstanding the foregoing, it is optimal that the outer exterior of the shroud housing have some aerodynamically compatible surface features in order to enhance any wind flow over the outer surface portion thereof to minimize wind interference.

In the specific embodiment set forth above, and as discussed above, the hollow chamber 50 is substantially enclosed except for an air intake opening 60A at or near the first end 40A of the housing 20, which air intake opening 60A is open to and otherwise preferably, but not essentially, faces forward from the frontal portion of shroud housing 20, optimally facing towards the prevailing windflow patterns, as particularly seen in the drawings. Moreover, it is preferable that the front portion 40A of the shroud housing 20 be positioned to face a direction to receive the maximum impact of wind during any portion of the day, as more fully described and as comprehended below. This latter features contemplates that the shroud housing 20 be positioned as a free standing member which is rotably mounted about the base member 3 for free rotation in a horizontal plane to face the frontal opening 40A of such shroud at any given time into the then existing wind flow. As indicated, in this later respect, shroud housing 20 should also have some form of aerodynamic features on the outer surfaces thereof to lessen any interference effect on wind flow frontally towards the shroud housing.

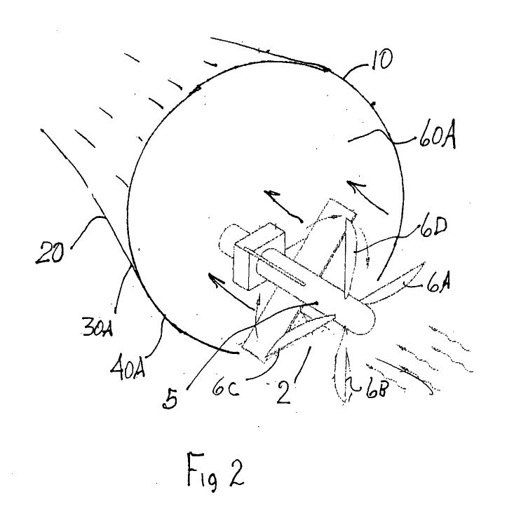

Thus, from the above description and as can be seen from the drawings, the internal hollow chamber 50 of shroud housing 20 is structured and formed as a longitudinally extending member a chamber extending from the first end 40A of housing 20 to second end 40B of such housing to an exit opening 60B or near such shroud second end 40B. As seen in the drawings, air inlet opening 60A is adapted to feed air into the hollow chamber 50, as shown schematically in FIGS. 2, 3, 4 and 5, from just behind the wind turbine blades 6A, 6B 6C and 6D to draw such air ultimately near the exit opening 60B to at or near the posterior or second end 40B of said shroud housing 20.

In constructing the specific embodiment, thusly described, the hollow chamber 50 in shroud housing 20 may be, but not necessarily, gradually tapered to a smaller perimeter or circumference in its spatial girth as it extends rearwardly from the air intake opening 60A to the air outlet opening 60B, as can be seen in the drawings. This tapering effect also helps to channel moving air into a gradually restricted area as the air flow moves rearwardly in such shroud chamber 50 to move such moving air, as a result, with increasingly greater velocity as it passes to the outlet opening 60B in such chamber. At or near the second end of the chamber 50 the outlet opening 60B, is structured to emit the flowing air from the enclosed chamber 50, as demonstrated schematically in FIGS. 2, 3, 4 and 5. Moreover, it is to be noted that the chamber 50 need not be structured to have a variable girth or circumference, and may be otherwise shaped than as described above.

In one specific embodiment, affixed and supported for rotational movement in the chamber 50 of shroud housing member 20 rotor shaft member 5 projects directly and frontally towards the portion of the shroud housing and through the air inlet opening 60A of the housing 20, and thus, specifically extends frontwardly generally, but not essentially parallel to the longitudinal central axis of chamber 50 and preferably directed towards the area of any prevailing winds. The rotor shaft member 5 can be mounted, as stated above, through a bearing element 74 in base member 3 disposed within shroud housing chamber 50 so that when the rotor shaft rotates, it will rotate about such fixed element 74 within the chamber 50. Rotor shaft 5 if affixed in the shroud housing chamber 50 can be supported through support structures 90A, 90B affixed in the housing chamber 50 or other nearby structures. The rotor shaft 5 can be thence interconnected to a generator, not shown, powered by the rotational movement of turbine rotor 5, with affixed wind turbine blades 6A, 6B, 6C and 6D.

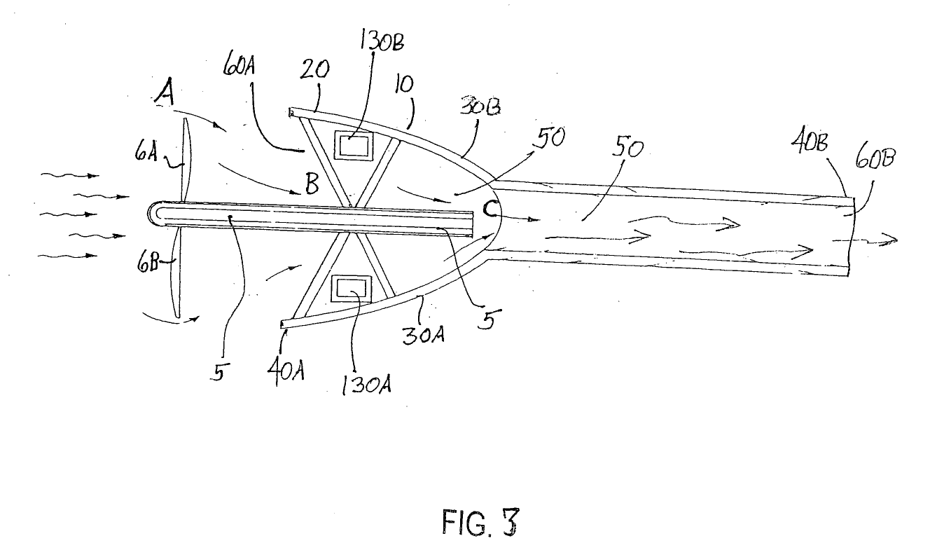

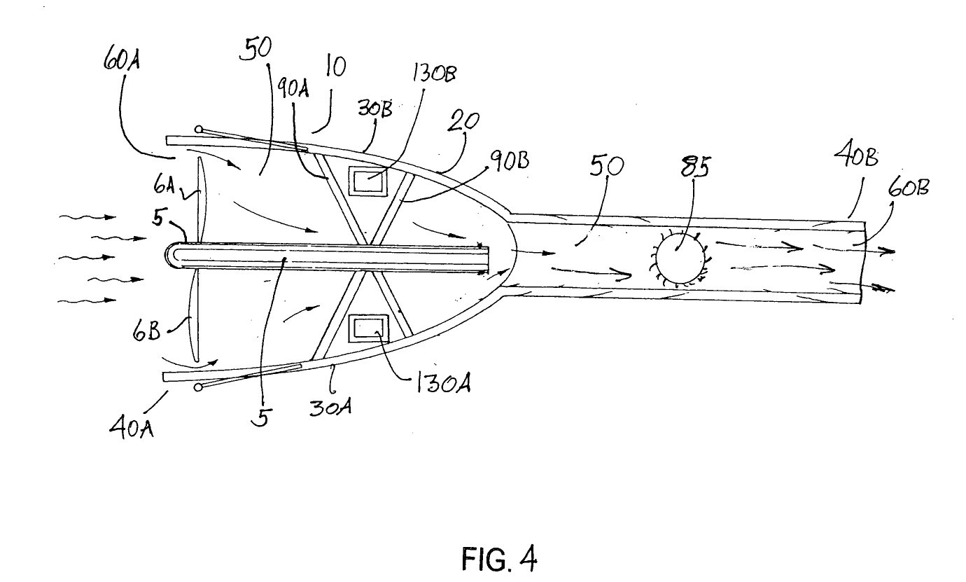

As described above, the rotor shaft 5 can be mounted in the housing chamber 50 with wind turbine blades 6A, 6B, 6C and 6D positioned just inside the chamber 50, as shown in FIG. 2, near the air inlet opening 60A, so that the exterior radically outer periphery of rotor blades 6A, 6B, 6C and 6D are within the housing chamber 50 positioned for unimpeded rotation within such housing chamber 50. Moreover, there should be sufficient open space in chamber 50 for the direct oncoming wind impinging at the shroud housing 20 to effectively drive the turbine blades 6A, 6B, 6C and 6D within chamber 50, without encountering eddy current effects interfering with such air flow. The turbine rotor blades can, however, be mounted in any position within the chamber 50 and not just at the frontal portion. However, in some embodiment the turbine blades 6A, 6B, 6C and 6D can be mounted on rotor 5 outside the shroud housing 20, as seen in FIGS. 3 and 4, or above or in front of such housing or in other positions. In this latter structural positioning, when the blades are mounted just in front of the air inlet opening 60A, the front portion of the rotor blade members 6A, 6B, 6C and 6D may face frontally towards the wind flow, as stated with the frontal portion of the rotor member 5 preferably extending outward away from the housing or beyond the first end 30A of the shroud housing 20. Wind turbine blades 6A, 6B, 6C and 6D then receive the impact of winds outside shroud housing 20 to drive the rotor 5 independently of any air movement forces generated within shroud housing 20 chamber 50. Further, the number of turbine blades deployed on the rotor member 5 is optional. The radially inner portions of rotor blades 6A, 6B, 6C and 6D are affixed in a radially-spaced manner on the outer surface of the rotor shaft to create a symmetrical arrangement of spacing of such rotor blades as is conventional. This latter aspect is not critical to implementation of the subject invention.

Moreover in an alternate arrangement, the rotor shaft 5 can be mounted just above the upper portion of housing 20, or in other dispositions or outside of the hollow chamber 50. Additionally, as the rotor shaft 5 preferably extends outwardly from the housing 20, it is essential that the rotor blades clear the housing for free rotational movement.

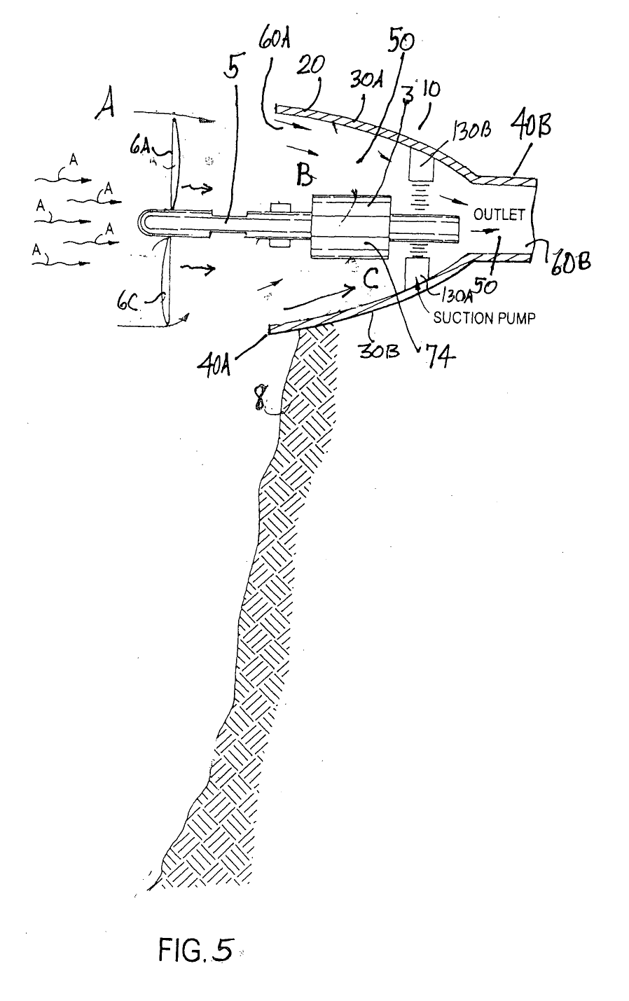

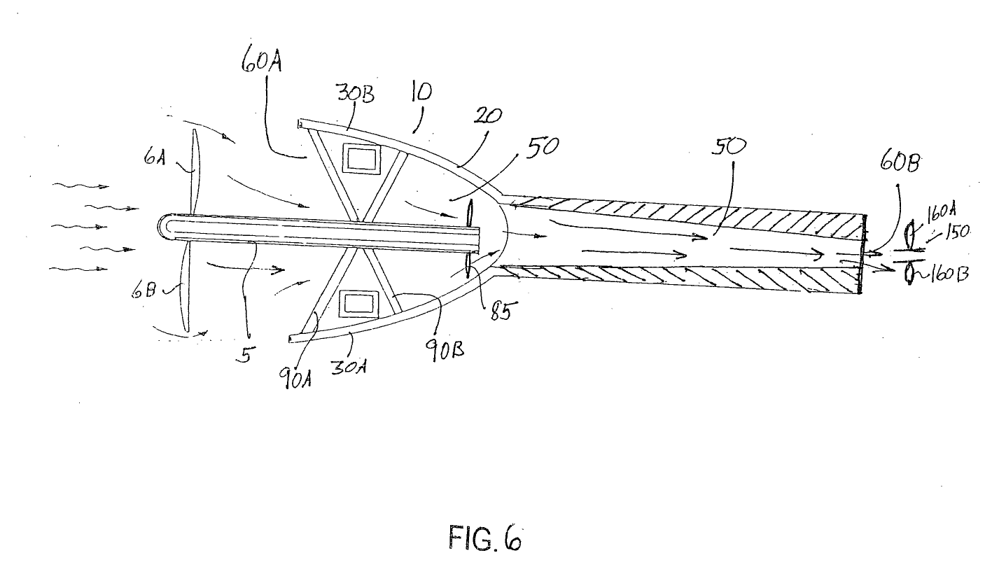

As stated previously, the progressive narrowing of the inner hollow chamber 50 is not critical, however, it is preferable to help funnel the posterior flow of air in the chamber to increase both the velocity and volume of the rearward air flow in chamber 50 towards air outlet opening 60B. In this latter aspect it is preferable that this progressive narrowing of the chamber 50 be directed as the chamber 50 extends towards the air outlet opening 60B, as seen in the drawings so that all the flow of air will be directed to vent from air outlet opening 50B at a relatively higher speed than the air movement speed in the frontal part of chamber 50. Thus air behind rotor blades 6A, 6B, 6C and 6D mounted in the front portion of the rotor 5 will be increased thus helping to draw more wind flow from areas just in front of such rotor blades. Shown in FIG. 5 is another embodiment wherein air flow in chamber 50 from air outlet opening 60A can be directed over a secondary set or rotor blades on rotor 5 just ahead of air outlet opening 60B. Since the rotor member 5 is mounted on a shaft that is preferably, but not essentially mounted in shroud housing 20 chamber 50, such resultant air flow is directed substantially over such second set 85 of rotor blades as schematically shown in the drawings in FIG. 6. The wind flow from the outside of chamber as it drives the rotor 5 wind turbine blades 6A, 6B, 6C and 6D can be used for powering the vacuum pumps 130A and 130B rotational movement of rotor 5 in chamber 50. These secondary set of rotor blades 85 can be used to drive vacuum pumps 130A and 130B in housing 20 providing supplemental energy input.

Also as seen in FIG. 6, in yet another embodiment of the subject invention, the air outlet opening 60B is positioned to direct all resultant air flow from chamber 50 over a rotor turbine 150 positioned just outside air outlet opening 60B. For this purpose, rotor 150 can be equipped and structured with one or more rotor blades preferably that are structured to receive efficiently the air flow of air from exit opening 60B as in a turbine arrangement or in a paddle-wheel arrangement. For this purpose, wind turbine blades 160A, 160B . . . are all affixed on their radially inner ends to an independent rotor member 150 positioned or near the housing 20 the aerodynamically formed rotor blades 160A, 160B . . . are adapted to receive the impact of air over such blades in an arrangement to impel air flow against the blades and rotate the rotor 150 in either a clockwise or counterclockwise manner, dependent on the blade formation. The thrust of air from such opening 60B is projected over such wind turbine 150 for independent energy production of that produced by rotor 5. The rotor 150 can be structured in other variations, such as an extension of rotor 5 through opening 60B.

As further seen from the view in FIGS. 2, 3, 4 and 5, the walls within chamber 50 are curved inwardly as they extend rearwardly through the chamber, so as to form a more gradually constricted space as the chamber extends backwardly. Thus, as can be observed, it is best that the most narrow part of the chamber 50 be at that portion just immediately adjacent or in front of exit opening 60B, as seen from the vantage point of FIGS. 3 and 4. As stated, at this point the internal chamber 50 terminates into an exit opening 60B that ejects the air flowing up through the chamber 50 coming from air intake opening 60A. As seen the air outlet opening 60B is adapted to propel air outwardly at a faster rate than the air coming into air inlet opening 60A. Alternatively stated, as indicated above, the air ejected from the chamber 50 through the air exit opening 60B can be useful in another embodiment, as described above, so that the air flowing out of the chamber 50 will impinge against the rotor blades of secondary rotor member 150 positioned behind air exit opening 60B and such constant air flow will maintain an impinging effect constantly as the continued flow of air is expelled against the rotor blades on secondary rotor mechanism 150. This restricted air flow pattern will keep air impinging against the rotor blades on the secondary rotor, 150 as so dynamically positioned.

This secondary rotor 150 could conceivably receive the impact of the air flow over the outside surfaces of the shroud housing 20, which would be even more effective if the outer surfaces of the shroud housing are aerodynamically formed as seen in FIGS. 3 and 4 and as discussed above. As stated, a rotor could be positioned in the chamber 50 of shroud housing secondary to receive the rearward flow of air in the chamber 50. Thus, shown in FIG. 6, an alternate secondary blade structure 85 can be located in chamber 50 at any position behind the primary rotor blades 6A, 6B, 6C and 6D and can be affixed on rotor 5 so that the rotor revolutions will be enhanced by such air impact on the secondary rotor blade set structure 85. Therefore, in this latter arrangement rotor 5, will thus be driven by two air flow force components. First, the oncoming head wind will drive the main turbine blades 6A, 6B, 6C and 6D, as in the case of an ordinary wind turbine, and the airflow in chamber 50 will also impinge the rotor blades on secondary rotor structure 300. This will provide two separate air movement components for movement of rotor 5.

As discussed above, to facilitate air flow through shroud housing chamber 50, one or more vacuum pumps 130A and 130B may be affixed in shroud housing chamber 50. These vacuum pumps can draw power from independent sources or be powered off rotor 5 as it revolves and either operate through mechanical forces or through an electric motor not shown or by way of independent electrical sources. The resultant increased air flow in the chamber 50 as caused by vacuum pumps 130A and 130B, or by the bernoulli effect, resulting from the flow of air through a gradually decreasing circumferential wall in chamber 50 will draw air into chamber 50 more rapidly and the primary wind turbine 5 rotor blades will benefit from the partial vacuum effect. The partial vacuum effect created in chamber 50 will thus create a limited suction effect drawing more air into the chamber 50 helping to increase the air flow over the appropriately positioned turbine blades 6A, 6B, 6C and 6D near inlet opening 60A in chamber 50 by the fact that incoming air coming towards the shroud housing 20 will be accelerated by the resultant suction effect of the partial vacuum created in chamber 50. This will increase the airflow over rotor blades 6A, 6B, 6C and 6D as a net result as schematically shown in FIG. 6.

Again, FIGS. 3, 4, 5 and 6 demonstrate dynamically what occurs in this wind flow effect when wind arrives at wind turbine blades 6A, 6B, 6C and 6D, at point A, near shroud housing 20, the flow will be increased into the chamber 50 by the of the relative lower air pressure or vacuum effect of the ambient air in the shroud housing 20 at point B. This effect creates a suction effect at or near the intake opening 60A in shroud housing chamber 50, and as air travels to point C in chamber 50 it will increase its flow rate by reason of the bernoulli effect or by the vacuum pump action. This will cause air approaching wind turbine blades 6A, 6B, 6C and 6D to increase at a more forcible rate and greater velocity so that the resultant air flow will have a greater impact against the blades on wind turbine blades 6A, 6B, 6C and 6D, being near or in the shroud housing chamber.

In all embodiments therein the rotor member 5 inside or outside the housing chamber 50 is structured to be freely rotatable, as driven by the primary rotor blades 6A, 6B, 6C and 6D, as more specifically discussed above, with the central concept being that air that is drawn up through the chamber 50, will experience enhanced flow from the bernoulli effect of the gradually restricted spacial area of the chamber or by the use of vacuum pumps 130A and 130B. The reduced air pressure or partial vacuum effect created in the frontal portion of the shroud housing chamber will cause air approaching wind turbine blades 6A, 6B, 6C and 6D to increase at a more forcible rate and greater velocity so that the resultant air flow will have a greater impact against the wind turbine blades on such wind turbine blades increasing thereby it rotation force or velocity.

Moreover, in some circumstances it may be optimal to position the shroud housing 20 in a horizontal position along the side of a mountain, hill or top of a cliff 6 as graphically represented in FIGS. 1 and 5. The reason for such position is to take advantage of the usual upward flow of winds or air currents up the side of a mountain during day time hours. This is not critical that the subject device be positioned on or near a cliff or mountains.

In summary, the subject invention is a structure for increasing the ambient air flow to drive a rotor mechanism comprising:

(a) a housing member having a frontal surface and a rear surface, such housing member having an internal chamber within such housing member, with such housing member having a frontal surface, an inlet opening to admit air flow into such chamber, and wherein such housing chamber has an outlet opening and an air, such air outlet opening being located posterior to such air inlet opening to eject air from said chamber.

Another summary is that the subject invention is a structure for harnessing air currents to drive a rotor mechanism comprising:

(a) a housing member having an outer surface, such housing member having an internal chamber with such housing member having a frontal wall comprising the enclosure to such chamber, with such frontal wall having a portion thereof which is translucent for admission of sunlight into such chamber, such housing member having an air inlet opening leading from spatial areas outside such housing member to spatial areas inside said chamber of such housing member;

(b) air outlet means on such housing member, such air outlet means extending from areas inside such chamber to spatial areas outside such chamber;

(c) air-driven rotor member having a central rotatable axle affixed to a position adjacent such air outlet means, such rotor-driven member having a rotor blade affixed to a portion of such rotatable axle for receiving incoming wind and wherein such rotor means has additional rotor blades to receive the impact of air escaping from such chamber in such housing.

Furthermore, the subject invention can be summarized as a combined solar powered and wind powered rotor mechanism comprising

(a) a housing member, such housing member having an internal longitudinally extending chamber, disposed with side such housing member, and wherein such housing member has an air inlet opening therein which extends from spatial areas outside such housing into such chamber, and wherein such housing has an air outlet opening to vent aid from such chamber;

(b) a rotor mechanism having a plurality of vane members to receive the impact of air vented from such air outlet opening and drive said rotor mechanism.

In further summary, the subject invention is a rotor apparatus structured to be driven by wind force and solar energy comprising:

(a) a housing member with an internal chamber with an upper portion and a lower portion, said housing member having a translucent front surface portion on the outside of solar chamber and a solar absorptive back surface portion with a solar energy collector chamber within such housing, with such chamber being disposed between such front surface portion and such back surface portion, such housing member having an air intake opening on the lower portion of such housing, which air intake opening leads to the solar energy collection chamber, such housing having an air outlet opening that emits passing air from the solar energy collection chamber, and further comprising;

(b) rotatable shaft means rotatably mounted through such housing member with a portion of such shaft projecting out from the front of such housing and a portion of such shaft passing through the solar absorption chamber, and further comprising;

(c) wind driven rotor means disposed concentricity on that portion of the rotatable shaft that projects frontally of the front surface, and further comprising;

(d) air driven means disposed on that portion of the rotor shaft in the chamber.

Further summarizing, the subject invention is a structure for augmenting wind flow over a wind turbine comprising:

(a) a housing member having an upper surface and a lower surface, said housing member having an internal chamber within said housing member, with said housing member having an air inlet opening and an air outlet opening said air outlet opening connecting with said chamber and said air out outlet opening connecting with said chamber;

(b) wind turbine means affixed on a rotor shad said wind turbine means being positioned adjacent to said air inlet opening to said chamber to receive wind movement from air outside said chamber onto said wind turbine means.

In still another summary of the subject invention, the invention is a structure for augmenting wind flow over a wind turbine comprising:

(a) a housing member having an upper surface and a lower surface, such housing member having an internal chamber within such housing member, with such housing member having an air inlet opening and an air outlet opening such air outlet opening connecting with such chamber and such air out outlet opening connecting with such chamber;

(b) wind turbine means affixed on a rotor shaft, such wind turbine means being positioned adjacent to such air inlet opening to said chamber to receive wind movement from air outside such chamber onto such wind turbine means;

(c) mechanical means disposed inside such chamber to create a partial vacuum inside such chamber.

Further, the subject invention is a structure for utilizing air currents to drive a rotor mechanism comprising:

(a) a housing member having an internal chamber formed in part by a first outer surface on such housing and a second outer surface, and wherein such first outer surface is translucent to admit sunlight through said first outer surface to said internal chamber and wherein such housing member has an air inlet opening to admit external air from spatial area outside said chamber, and an air outlet opening to admit air from such chamber;

(b) a housing member having an outer surface, such housing member having an internal chamber with said housing member having a frontal wall comprising the enclosure to said chamber, with said frontal wall having a portion thereof which is translucent for admission of sunlight into said chamber, such housing member having an air inlet opening leading from spatial areas outside said housing member to spatial areas inside such chamber of said housing member;

(c) air outlet means on said housing member, such air outlet means extending from areas inside said chamber to spatial areas outside said chamber;

(d) air-driven rotor member having a central rotatable axle affixed to a position adjacent said air outlet means, said rotor-driven member having a rotor blade affixed to a portion of said rotatable axle for receiving incoming wind and wherein such rotor means has additional rotor blades to receive the impact of air escaping from such chamber in said housing.

1. A structure for augmenting wind flow over a wind turbine comprising:
(a) a housing member having an upper surface and a lower surface, said housing member having an internal chamber within said housing member, with said housing member having an air inlet opening and an air outlet opening said air outlet opening connecting with said chamber and said air out outlet opening connecting with said chamber;
(b) wind turbine means affixed on a rotor shaft, said wind turbine means being positioned adjacent to said air inlet opening to said chamber to receive wind movement from air outside said chamber onto said wind turbine means.

2. A structure for augmenting wind flow over a wind turbine comprising:
(a) a housing member having an upper surface and a lower surface, said housing member having an internal chamber within said housing member, with said housing member having an air inlet opening and an air outlet opening said air outlet opening connecting with said chamber and said air out outlet opening connecting with said chamber;
(b) wind turbine means affixed on a rotor shaft, said wind turbine means being positioned adjacent to said air inlet opening to said chamber to receive wind movement from air outside said chamber onto said wind turbine means;
(c) mechanical means disposed inside said chamber to create a partial vacuum inside said chamber.

3. A structure for utilizing air currents to drive a rotor mechanism comprising:
(a) a housing member having an internal chamber formed in part by a first outer surface on said housing and a second outer surface, and wherein said first outer surface is translucent to admit sunlight through said first outer surface to said internal chamber and wherein said housing member has an air inlet opening to admit external air from spatial area outside said chamber, and an air outlet opening to admit air from said chamber;
(b) a housing member having an outer surface, said housing member having an internal chamber with said housing member having a frontal wall comprising the enclosure to said chamber, with said frontal wall having a portion thereof which is translucent for admission of sunlight into said chamber, said housing member having an air inlet opening leading from spatial areas outside said housing member to spatial areas inside said chamber of said housing member;
(c) air outlet means on said housing member, said air outlet means extending from areas inside said chamber to spatial areas outside said chamber;
(d) air-driven rotor member having a central rotatable axle affixed to a position adjacent said air outlet means, said rotor-driven member having a rotor blade affixed to a portion of said rotatable axle for receiving incoming wind and wherein said rotor means has additional rotor blades to receive the impact of air escaping from said chamber in said housing.
